(19) United States
(12) Patent Application Publication
(10) Pub. No.: US 2025/0317523 A1
(43) Pub. Date: Oct. 9, 2025

(54) RECORDING APPARATUS

(71) Applicant: SEIKO EPSON CORPORATION, Tokyo (JP)

(72) Inventors: Keita FUJI, MATSUMOTO-SHI (JP); Shintaro MIYAMOTO, SHIOJIRI-SHI (JP); Masaki ICHIKAWA, MATSUMOTO-SHI (JP)

(21) Appl. No.: 19/171,644

(22) Filed: Apr. 7, 2025

(30) Foreign Application Priority Data
Apr. 8, 2024 (JP) 2024-061991

(51) Int. Cl. H04N 1/00

(52) U.S. Cl. CPC H04N 1/00559; H04N 1/00543; H04N 1/00564; H04N 1/00795; H04N 2201/0094

(57) ABSTRACT

A recording apparatus includes a lower unit and an upper unit, the upper unit includes an arm, the lower unit includes an opening that the arm enters and a cam groove in which a route on which a projection of the arm moves is formed, and the cam groove includes a first route on which the projection passes when the upper unit is opened from a closed state, a second route on which the projection passes when the upper unit is closed from the open state, a transition route on which the projection passes when the projection moves from the first route to the second route, and a third route for enabling the arm to be attached and detached.

The present application is based on, and claims priority from JP Application Serial Number 2024-061991, filed Apr. 8, 2024, the disclosure of which is hereby incorporated by reference herein in its entirety.

### BACKGROUND

### 1. Technical Field

The present disclosure relates to a recording apparatus.

### 2. Related Art

In the related art, a so-called multifunction peripheral in which a printer serving as a lower unit and a scanner serving as an upper unit that can be opened and closed with respect to the lower unit are integrated has been used. For example, JP-A-2014-176005 discloses an image forming apparatus including a main body serving as a lower unit, an image reading housing unit serving as an upper unit, and a lever coupled to the main body and the image reading housing unit and capable of maintaining the image reading housing unit in an open state with respect to the main body.

JP-A-2014-176005 is an example of the related art.

In general, a recording apparatus of the related art including a lower unit and an upper unit like the image forming apparatus disclosed in JP-A-2014-176005 includes an arm that maintains the upper unit in an open state with respect to the lower unit like the lever disclosed in JP-A-2014-176005. When the recording apparatus is assembled or when the recording apparatus is maintained, the arm is sometimes detached from the lower unit or the upper unit in order to largely open the upper unit with respect to the lower unit. However, the arm, an attachment section of the arm, or the like is sometimes damaged when the arm is attached or detached. This is because, for example, when the arm is attached or detached, it is sometimes necessary to twist the arm in order to remove the arm from a member that supports the arm. At that time, for example, the arm or the like is sometimes deformed and damaged. For this reason, it is necessary for an operator to carefully attach and detach the arm in order to prevent the damage of the arm or the like. Workability is sometimes deteriorated when the recording apparatus is assembled or when the recording apparatus is maintained.

### SUMMARY

According to an aspect of the present disclosure, there is provided a recording apparatus including: a lower unit including a recording section configured to perform recording on a medium; and an upper unit including a reading section configured to read an image of a document, the upper unit being provided in an upper part of the lower unit and being openable and closable with respect to the lower unit, wherein the upper unit includes an arm supported by the lower unit and configured to maintain an open state of the upper unit, the arm is rotatably provided with respect to the upper unit, the lower unit includes: a housing configuring an outer shell; an opening formed in an upper part of the housing, the arm entering the opening; and a cam groove configured to receive a projection provided on the arm, a route on which the projection moves in a certain direction when the upper unit is opened and closes being formed in the cam groove, a recess into which the projection enters and that supports the projection from below is provided in the cam groove, an open state of the upper unit is maintained when the projection enters the recess, and the cam groove includes: a first route that is a route on which the projection passes when the upper unit is opened from a closed state; a second route that is a route on which the projection passes when the upper unit is closed from the open state; a transition route that is a route on which the projection passes when moving from the first route to the second route; and a third route that is a route for enabling the arm to be attached and detached.

### BRIEF DESCRIPTION OF THE DRAWINGS

FIG. 1 is a perspective view of a recording apparatus in an embodiment and is a diagram illustrating a state in which an upper unit is closed with respect to a lower unit.

FIG. 2 is a perspective view of the recording apparatus in FIG. 1 and is a diagram illustrating a state in which the upper unit is disposed at a first open position with respect to the lower unit.

FIG. 3 is a perspective view of the recording apparatus in FIG. 1 and is a diagram illustrating a state in which the upper unit is disposed at a second open position with respect to the lower unit.

FIG. 4 is a perspective view of the recording apparatus in FIG. 1 and is a diagram illustrating a state in which the upper unit is disposed at a third open position with respect to the lower unit.

FIG. 5 is a perspective view of the recording apparatus of FIG. 1 and is a diagram illustrating a state in which the upper unit is disposed at a fourth open position with respect to the lower unit.

FIG. 6 is a perspective view of the periphery of an arm and an opening into which the arm is inserted of the recording apparatus in FIG. 1.

FIG. 7 is a perspective view of the arm of the recording apparatus in FIG. 1.

FIG. 8 is a side view illustrating a route of a projection of the arm of the recording apparatus in FIG. 1.

FIG. 9 is a side view illustrating a moving route of the projection at the time when the upper unit is moved to a closed position, a first open position, a second open position, and a closed position in this order with respect to the lower unit in the recording apparatus in FIG. 1.

FIG. 10 is a side view illustrating a moving route of the projection at the time when the upper unit is moved to the first open position, a third open position, and a fourth open position in this order with respect to the lower unit in the recording apparatus in FIG. 1.

FIG. 11 is a side view illustrating a moving route of the projection at the time when the upper unit is moved to the fourth open position and the second open position in this order with respect to the lower unit in the recording apparatus of FIG. 1.

FIG. 12 is a front view of the recording apparatus in FIG. 1 and is a diagram illustrating a state in which the upper unit is disposed at a fifth open position with respect to the lower unit.

FIG. 13 is a side view illustrating a W-W cross section of FIG. 12.

FIG. 14 is a perspective view illustrating the periphery of a paper discharge tray and the opening into which the arm is inserted of the recording apparatus in FIG. 1.

FIG. 15 is a side view illustrating the periphery of the paper discharge tray and the opening into which the arm is inserted of the recording apparatus in FIG. 1.

### DESCRIPTION OF EMBODIMENTS

The present disclosure is schematically described below.

According to a first aspect of the present disclosure, there is provided a recording apparatus including: a lower unit including a recording section configured to perform recording on a medium; and an upper unit including a reading section configured to read an image of a document, the upper unit being provided in an upper part of the lower unit and being openable and closable with respect to the lower unit, wherein the upper unit includes an arm supported by the lower unit and configured to maintain an open state of the upper unit, the arm is rotatably provided with respect to the upper unit, the lower unit includes: a housing configuring an outer shell; an opening formed in an upper part of the housing, the arm entering the opening; and a cam groove configured to receive a projection provided on the arm, a route on which the projection moves in a certain direction when the upper unit is opened and closes being formed in the cam groove, a recess into which the projection enters and that supports the projection from below is provided in the cam groove, an open state of the upper unit is maintained when the projection enters the recess, and the cam groove includes: a first route that is a route on which the projection passes when the upper unit is opened from a closed state; a second route that is a route on which the projection passes when the upper unit is closed from the open state; a transition route that is a route on which the projection passes when moving from the first route to the second route; and a third route that is a route for enabling the arm to be attached and detached.

According to this aspect, the projection is provided on the arm. The lower unit includes the cam groove in which the route on which the projection of the arm moves is formed. The recess that supports the projection from below is provided in the cam groove. The cam groove includes the first route, the second route, the transition route, and the third route. The first route is the route on which the projection passes when the upper unit is opened from the closed state. The second route is the route on which the projection passes when the upper unit is closed from the open state. The transition route is the route on which the projection passes when moving from the first route to the second route. The third route is the route for enabling the arm to be attached and detached. With such a configuration, for example, when the recording apparatus is assembled, the arm can be attached to and detached from the lower unit by inserting the projection into and removing the projection from the cam groove via the third route. Accordingly, the arm can be easily attached to and detached from the lower unit without being twisted. Therefore, the assemblability of the recording apparatus including the lower unit and the upper unit can be improved.

A second aspect of the present disclosure is an aspect dependent from the first aspect, wherein the second route includes a linear extension route, and the third route includes a linear route extending along the extension route.

According to this aspect, the second route includes the linear extension route, and the third route includes the linear route extending along the extension route. With such a configuration, it is possible to prevent the second route and the third route from expanding. Therefore, it is possible to reduce the apparatus in size.

A third aspect of the present disclosure is an aspect dependent from the first or second aspect, wherein the first route includes a linear route in a vertically upward direction, the second route includes a route bent in a vertically downward direction, the transition route includes a route directed in an obliquely downward direction from an upper end of the first route and then directed in an obliquely upward direction toward an upper end of the second route, the cam groove includes, as the recess, a first recess provided in the transition route and a second recess provided at a position vertically lower than the first recess in the second route, and the first recess and the second recess are disposed side by side in a vertical direction.

According to this aspect, the cam groove includes, as the recess, the first recess provided in the transition route and the second recess provided at the position vertically below the first recess in the second route, and the first recess and the second recess are disposed side by side in the vertical direction. With such a configuration, it is possible to prevent the transition route and the second route from expanding. Therefore, it is possible to reduce the apparatus in size.

A fourth aspect of the present disclosure is an aspect dependent from any one of the first to third aspects, further including a pressing section configured to press the arm in a first direction such that the projection moves in the certain direction.

According to this aspect, the recording apparatus further includes the pressing section configured to press the arm such that the projection moves in the certain direction. With such a configuration, the projection can appropriately move in the certain direction.

A fifth aspect of the present disclosure is an aspect dependent from the fourth aspect, wherein the third route includes a butting section against which the projection butts when the projection passes the third route according to the arm being pressed in the first direction by the pressing section when the upper unit is moved in an opening direction with respect to the lower unit.

According to this aspect, the third route includes the butting section. When the upper unit is moved in the opening direction with respect to the lower unit, the projection butts against the butting section when the projection passes the third route according to the arm being pressed in the first direction by the pressing section. With such a configuration, it is possible to prevent the arm from unintentionally slipping out from the opening when an operator opens the upper unit.

A sixth aspect of the present disclosure is an aspect dependent from the fourth or fifth aspect, wherein the third route branches from the second route at a branching position in the second route, the second route is disposed further on the first direction side than the first route and the third route is disposed further on the first direction side than the second route, the transition route is configured such that the projection moves from the first route to the second route when the upper unit is moved in a closing direction with respect to the lower unit and thereafter moved in an opening direction, and the second route is configured such that, when the projection is present at the branching position, the projection reaches a return route returning to the first route when the upper unit is moved in the closing direction with respect to the lower unit and reaches the third route when the upper unit is moved in the opening direction with respect to the lower unit.

According to this aspect, the second route is disposed further on the first direction side than the first route, and the third route is disposed further on the first direction side than the second route. For this reason, the projection can be moved from the first route to the second route and can be moved from the second route to the third route by a pressing force of the pressing section. The transition route is configured such that the projection moves from the first route to the second route when the upper unit is moved in the closing direction and thereafter moved in the opening direction. The second route is a route that can return the projection to the first route by closing the upper unit when the projection is present at the branching position. The second route is a route on which the arm can be discharged from the opening by opening the upper unit when the projection is present at the branching position. For this reason, the upper unit can be easily disposed at a desired position with respect to the lower unit.

A seventh aspect of the present disclosure is an aspect dependent from any one of the first to sixth aspects, wherein the cam groove includes, on an upper side of the recess, a guide surface that guides the projection in the certain direction.

According to this aspect, the cam groove includes, on the upper side of the recess, the guide surface that guides the projection in the certain direction. With such a configuration, when the upper unit is closed from a state in which the projection is supported by the recess, that is, a state in which the open posture of the upper unit is maintained, the moving direction of the projection can be restricted to an appropriate direction.

An embodiment is specifically described. In the following explanation, a printer 1, which is an inkjet printer, is described as an example of a recording apparatus according to the embodiment. In the recording apparatus, a scheme of performing recording on paper, which is an example of a medium, is not limited to an inkjet scheme. Various schemes such as an electrophotographic scheme and a dot impact scheme can be adopted. In the inkjet scheme, there are various forms such as a type in which an ink cartridge is mounted on a carriage 7 and a type in which an ink storage section is provided outside the carriage 7 and the ink storage section and the carriage 7 are connected by an ink tube. The recording apparatus according to the embodiment can be applied to all the forms. The printer 1 in the present embodiment is the type in which the ink cartridge is mounted in the carriage 7.

In an X-Y-Z coordinate system illustrated in the figures, an X direction indicates an apparatus width direction and a paper width direction based on the lower unit 2. In the X-Y-Z coordinate system, a Y direction indicates a paper conveyance direction and an apparatus depth direction at the time when recording is performed on paper in the lower unit 2. In the X-Y-Z coordinate system, a Z direction indicates the apparatus height direction and the vertical direction. A +Y direction is a direction from the apparatus rear surface toward the apparatus front surface and a −Y direction is a direction from the apparatus front surface toward the apparatus rear surface. The apparatus front surface is a surface facing an operator in the apparatus Which side surface among side surfaces of the apparatus is the apparatus front surface is determined based on an apparatus configuration and exterior design. As an example, when an operation section that includes various operation buttons and a display section and receives operation by the operator is provided, a side on which the operation section is provided is often a side facing the operator.

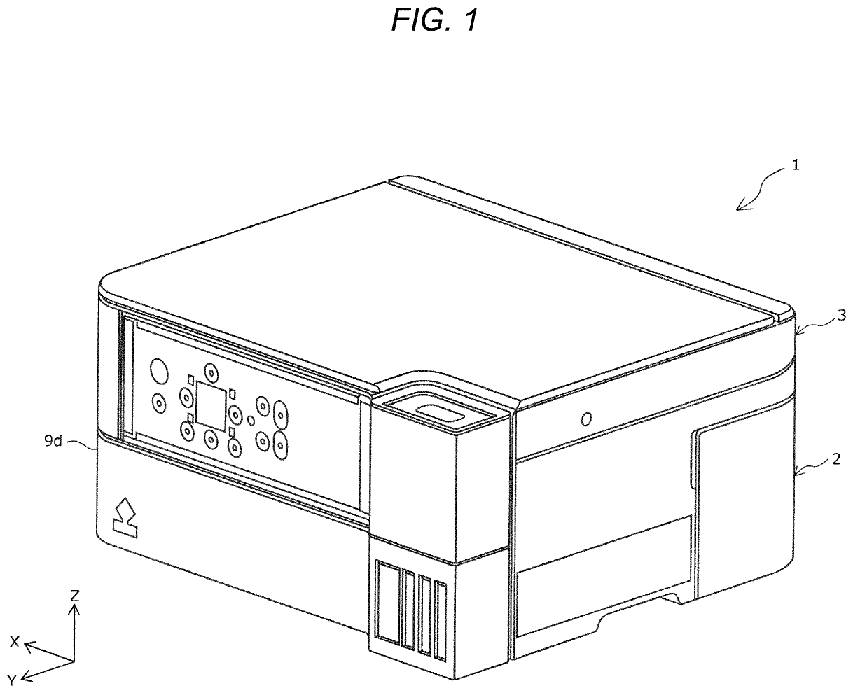

In FIGS. 1 to 5, the printer 1 includes a lower unit 2 that performs recording on paper and an upper unit 3 configured as a scanner that is an example of an image reading apparatus. That is, the printer 1 is a so-called multifunction peripheral. As illustrated in FIGS. 1 to 5, the upper unit 3 rotates with respect to the lower unit 2 and opens and closes.

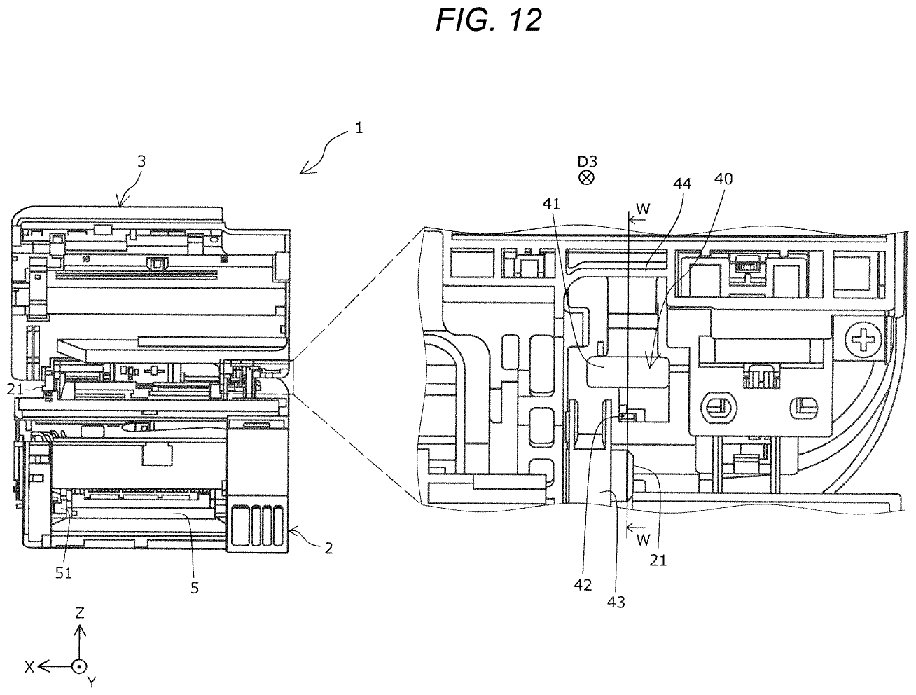

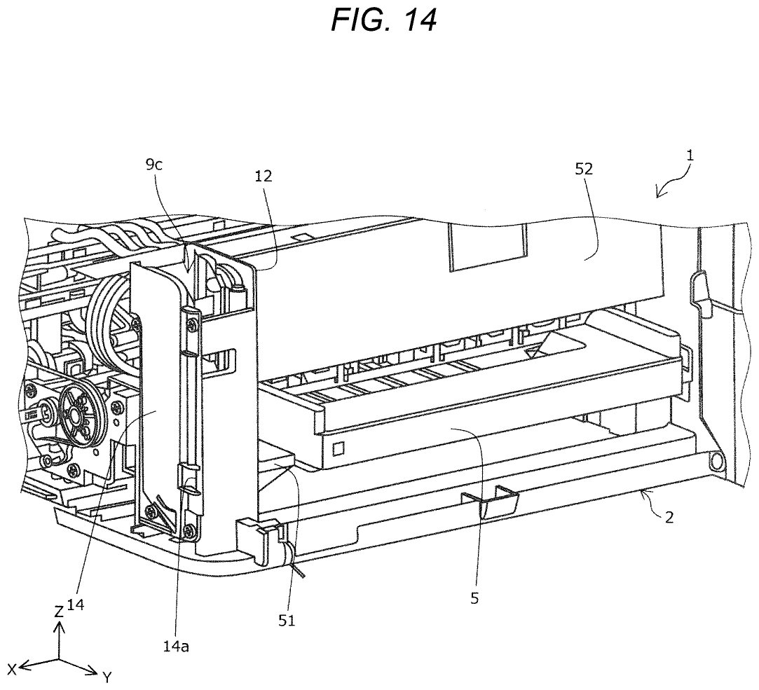

The upper unit 3 is a flatbed type scanner, includes a document table and a reading section, both of which are not-illustrated. A document placed on the document table is read by the reading section moving in the X direction. As illustrated in FIGS. 12 and 14, in the lower unit 2, a paper discharge tray 5 that receives paper, which is an example of a medium, subjected to recording and discharged is provided.

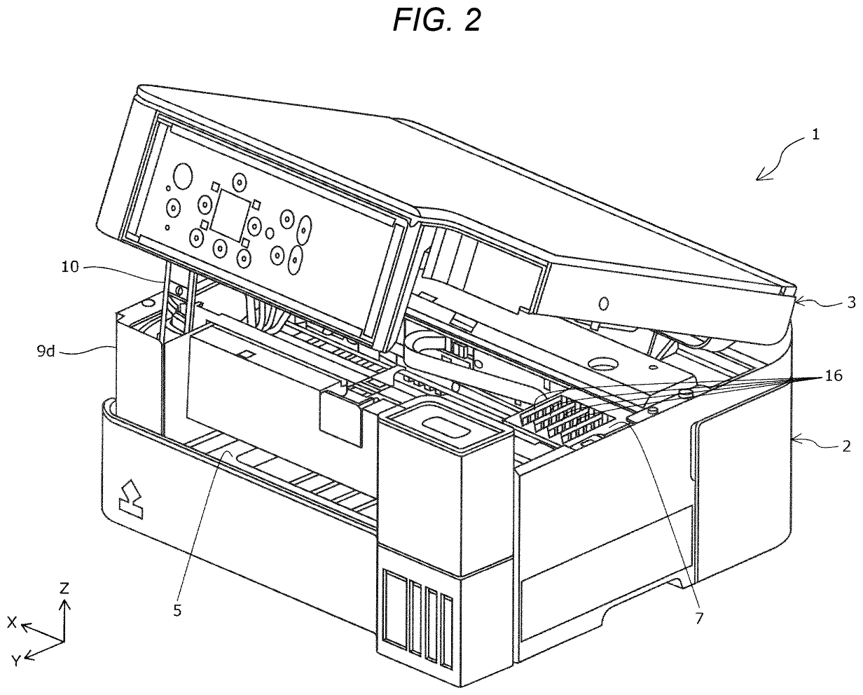

As illustrated in FIG. 2 and the like, the lower unit 2 includes a carriage 7 configuring a recording section. A recording head that discharges ink to paper is provided in the carriage 7. In the carriage 7, a plurality of ink cartridges 16 are provided.

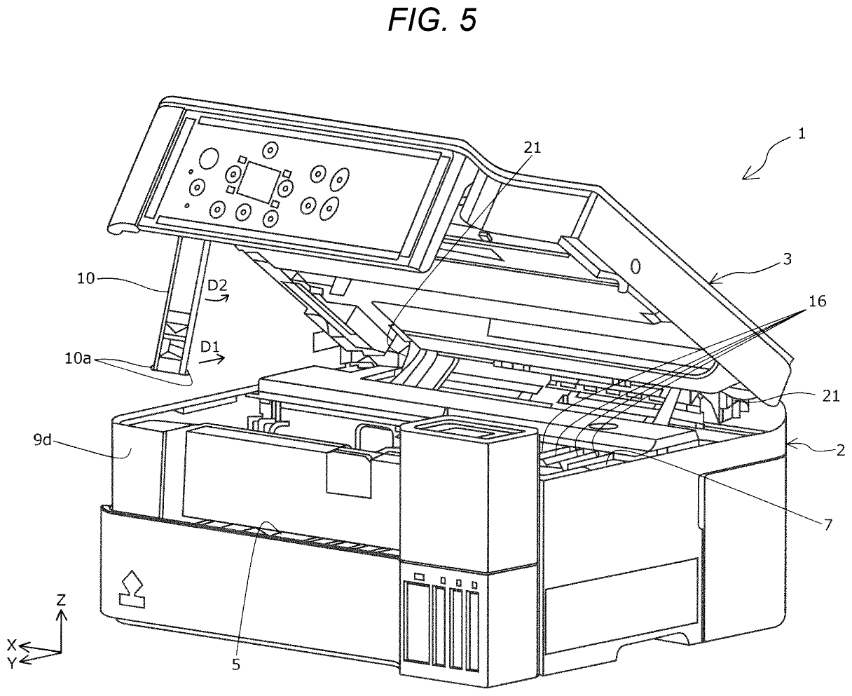

Subsequently, an arm 10 that maintains the open state of the upper unit 3 and cam grooves 30 that support the arm 10 are described. The upper unit 3 is turnably coupled to the lower unit 2 via a hinge 21 illustrated in FIG. 5 and the like. As illustrated in FIGS. 5 to 7, the upper unit 3 includes the arm 10. The arm 10 is supported by the lower unit 2, whereby a state in which the upper unit 3 is opened with respect to the lower unit 2 can be maintained.

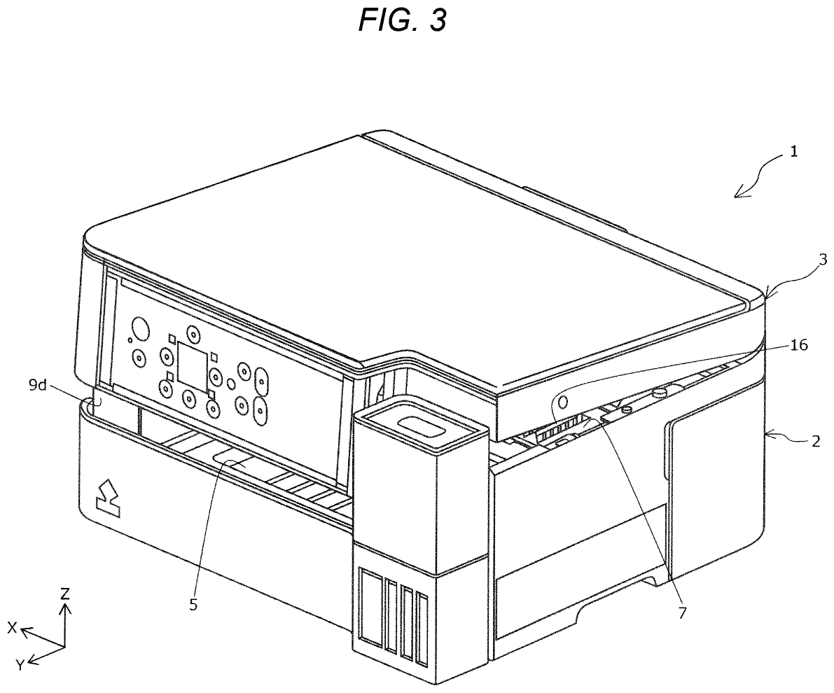

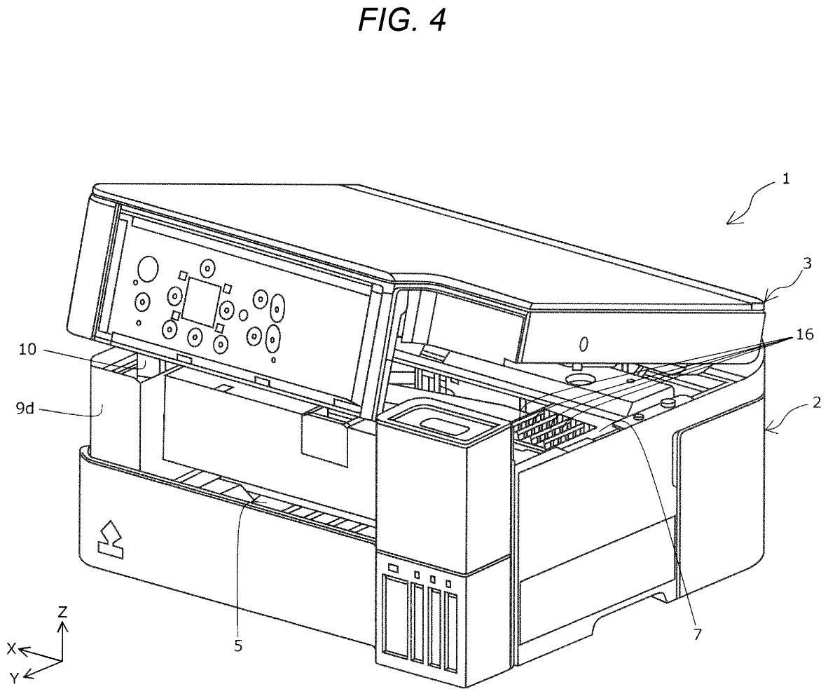

In the printer 1, the upper unit 3 is configured to be capable of taking a closed position illustrated in FIG. 1, a first open position illustrated in FIG. 2, a second open position illustrated in FIG. 3, a third open position illustrated in FIG. 4, a fourth open position illustrated in FIG. 5, and a fifth open position illustrated in FIG. 12 with respect to the lower unit 2. An opening angle of the upper unit 3 with respect to the lower unit 2 increases in the order of the second open position illustrated in FIG. 3, the third open position illustrated in FIG. 4, the first open position illustrated in FIG. 2, the fourth open position illustrated in FIG. 5, and the fifth open position illustrated in FIG. 12.

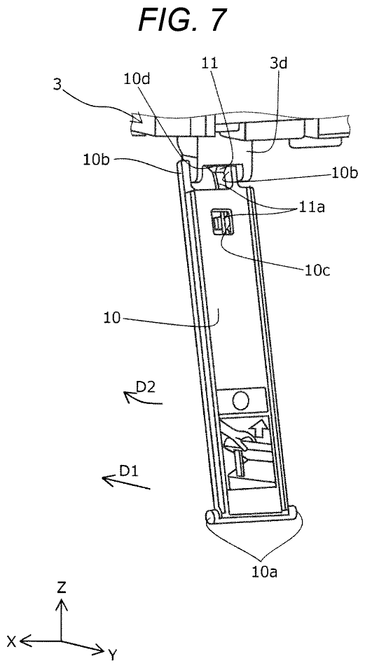

As illustrated in FIG. 7, the arm 10 includes two turning shafts 10b in an upper part and includes two projections 10a in a lower part. The turning shaft 10b is turnably supported by a support section 3d provided at the bottom of the upper unit 3. A spring holding section 10d is formed between the two turning shafts 10b. A torsion spring 11 is held by the spring holding section 10d. One end 11a of the torsion spring 11 is hooked on a spring hooking section 10c formed on the arm 10 and the other end of the torsion spring 11 is hooked on a not-illustrated spring hooking section formed on the bottom surface of the upper unit 3. Accordingly, the torsion spring 11 presses the arm 10 in a first direction D1, that is, to the apparatus rear side. That is, the torsion spring 11 presses the arm 10 to rotate the arm 10 centering on the turning shaft 10b in a turning direction D2 illustrated in FIG. 5 and the like.

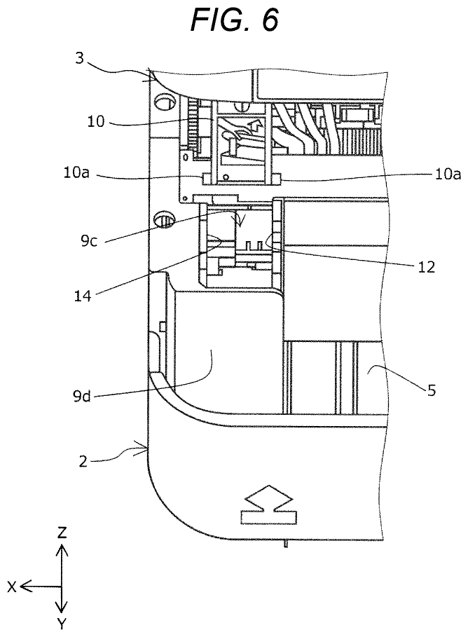

As illustrated in FIG. 6, the arm 10 enters the inner side of a housing 9d of the lower unit 2 via an opening 9c. The opening 9c is formed in an upper part of the housing 9d configuring an outer shell of the lower unit 2. The arm 10 is sandwiched between a first frame member 12 and a second frame member 14 configuring the lower unit 2. Projections 10a formed on both sides of the arm 10 are received in the cam grooves 30 formed in the first frame member 12 and the second frame member 14 and are guided when the upper unit 3 is opened and closed. The cam grooves 30 formed in the first frame member 12 and the second frame member 14 are formed in a symmetrical shape with the arm 10 interposed therebetween.

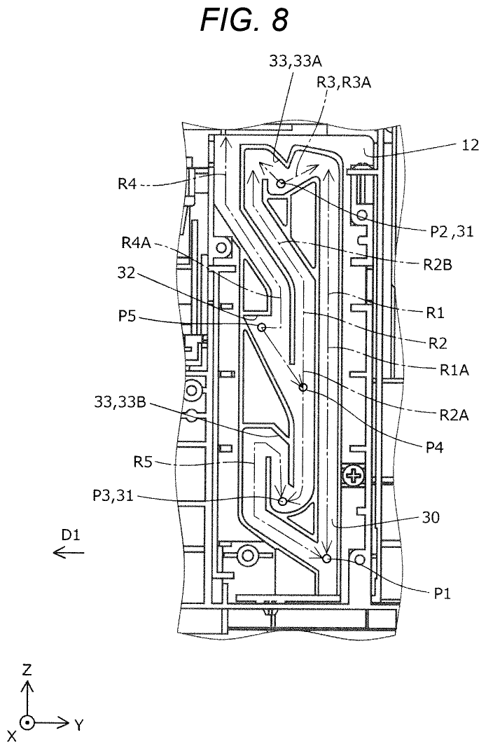

FIGS. 8 to 11 illustrate the cam groove 30 formed in the first frame member 12. As described above, the cam groove 30 is also formed in the second frame member 14. The cam groove 30 formed in the second frame member 14 is symmetrical to the cam groove 30 formed in the first frame member 12. The cam grooves 30 guide the projections 10a of the arm 10 and supports the projections 10a to support the upper unit 3. For this reason, the cam grooves 30 do not always need to be provided on both the sides of the arm 10. For example, the cam groove 30 may be formed in only one of the first frame member 12 and the second frame member 14 disposed with the arm 10 interposed therebetween. However, by providing the cam grooves 30 in both of the first frame member 12 and the second frame member 14 disposed with the arm 10 interposed therebetween, the projections 10a can be more appropriately supported and guided. Here, according to the upper unit 3 being opened and closed with respect to the lower unit 2, the projections 10a move in the cam groove 30 in a certain direction as indicated by an arrow A1 to an arrow A3 described below.

In the printer 1 in the present embodiment, an interval in the X direction between the projections 10a of the arm 10 and the cam grooves 30 is slightly provided. However, without being limited to such a configuration, the projections 10a may move in the cam grooves 30 while the projections 10a and the cam grooves 30 are always in contact with each other in the X direction.

As described above, the printer 1 includes the lower unit 2 including the recording section that performs recording on a medium and the upper unit 3 that is a reading section that reads an image of a document. The upper unit 3 is provided in an upper part of the lower unit 2 and can be opened and closed with respect to the lower unit 2. The upper unit 3 includes the arm 10 that is supported by the lower unit 2 and maintains the open state of the upper unit 3. Here, the arm 10 is rotatably provided with respect to the upper unit 3. The lower unit 2 includes the housing 9d, the opening 9c, and the cam grooves 30. The housing 9d configures the outer shell of the lower unit 2. The opening 9c is formed in an upper part of the housing 9d and the arm 10 can be inserted into the opening 9c. The cam grooves 30 receive the projections 10a provided on the arm 10 and a route is formed on which the projections 10a move in a certain direction when the upper unit 3 is opened and closed is formed.

The shape of the cam groove 30 is described in detail with reference to FIGS. 8 to 11. When the upper unit 3 is opened and closed, the projection 10a moves in the cam groove 30. The width of the cam groove 30 is set to be larger than the diameter of the projection 10a, that is, the cam groove 30 is formed at the width for enabling the projection 10a to smoothly move in the cam groove 30.

As illustrated in FIG. 8, the cam groove 30 includes a first route R1, a second route R2, a transition route R3, and a third route R4. The first route R1 is a route on which the projection 10a passes when the upper unit 3 is opened from the closed state. The second route R2 is a route on which the projection 10a passes when the upper unit 3 is closed from the open state. The transition route R3 is a region where the projection 10a passes when moving from the first route R1 to the second route R2. The third route R4 is a route that branches from the second route R2 at a fourth position P4, which is a branching position, and enables the arm 10 to be attached and detached. A recess 31 in which the projection 10a enters the transition route R3 and the second route R2 to support the projection 10a from below is provided in the cam groove 30. The projection 10a enters the recess 31, whereby the open state of the upper unit 3 is maintained.

As described above, in the printer 1, the recess 31 that supports the projection 10a from below is provided in the cam groove 30. The cam groove 30 configures the first route R1, the second route R2, the transition route R3, and the third route R4 configured as described above. With the above configuration, in the printer 1, for example, when the printer 1 is assembled, the arm 10 can be attached to and detached from the lower unit 2 by inserting the projection 10a into the cam groove 30 and removing the projection 10a from the cam groove 30 via the third route R4. Accordingly, the arm 10 can be easily attached to and detached from the lower unit 2 without being twisted. Therefore, the assemblability of the printer 1 including the lower unit 2 and the upper unit 3 can be improved.

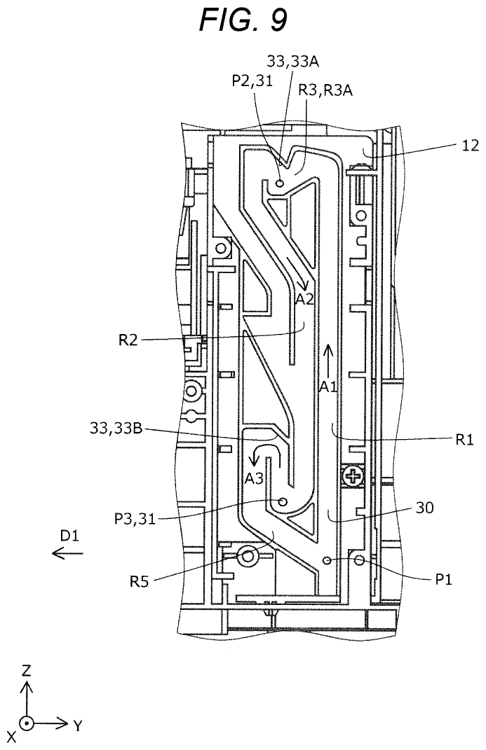

Here, disposition of the projection 10a in the cam groove 30 at the time when the upper unit 3 is opened and closed with respect to the lower unit 2 is described. First, mainly with reference to FIG. 9, disposition of the projection 10a in the cam groove 30 involved in normal opening and closing operations of the upper unit 3 at the time when the operator replaces an ink cartridge 16 according to the use of the printer 1 is described. In a state in which the upper unit 3 is located at the closed position with respect to the lower unit 2 as illustrated in FIG. 1, the projection 10a is located at a first position P1 in FIG. 9.

By changing a state in which the upper unit 3 is present at the closed position with respect to the lower unit 2 to a state in which the upper unit 3 is present at the first open position illustrated in FIG. 2, the projection 10a is displaced from the first position P1 to a second position P2. At this time, the projection 10a advances on the first route R1 and the transition route R3 as indicated by an arrow A1. The first route R1 is a route having a substantially straight shape in the vertically upward direction. The transition route R3 is formed in a shape extending in an obliquely downward direction from the upper end, that is, the terminal end of the first route R1 and then extending in an obliquely upward direction toward the upper end, that is, the starting end of the second route R2. The first position P1 is the bottom end of the first route R1 and the second position P2 is the recess 31 that supports the projection 10a from below and is the bottom end of the transition route R3. The state in which the upper unit 3 is present at the first open position with respect to the lower unit 2 illustrated in FIG. 2 corresponds to a position at the time when, for example, the ink cartridge 16 is replaced.

When the upper unit 3 is once opened with respect to the lower unit 2 and thereafter closed, the upper unit 3 changes from the first open position illustrated in FIG. 2 to the second open position illustrated in FIG. 3. At this time, the projection 10a advances on the transition route R3 and the second route R2 as indicated by an arrow A2 and changes from a state in which the projection 10a is located at the second position P2 to a state of in which the projection 10a is located at the third position P3. The second route R2 is formed in a shape bent in a vertically downward direction. The third position P3 is the recess 31 that supports the projection 10a from below and is the bottom end of the second route R2. The state in which the upper unit 3 is present at the second open position with respect to the lower unit 2 illustrated in FIG. 3 corresponds to a position for preventing a finger of the operator from being erroneously sandwiched between the lower unit 2 and the upper unit 3. From another point of view, even if the operator releases a hand in a state in which the upper unit 3 is widely opened, that is, a state in which the upper unit 3 is present at the first open position, the upper unit 3 does not shift to a completely closed state at once. Even if the operator releases a hand in a state in which the upper unit 3 is present at the first open position, the rotation of the upper unit 3 once stops at the second open position illustrated in FIG. 3. Therefore, it is possible to suppress generation of sound and damage caused by the upper unit 3 vigorously closing.

When the upper unit 3 is once opened with respect to the lower unit 2 and thereafter closed, the upper unit 3 changes from the second open position illustrated in FIG. 3 to the closed position illustrated in FIG. 1. At this time, the projection 10a moves along the return route R5 as indicated by an arrow A3 and returns from the state in which the projection 10a is located at the third position P3 to the state in which the projection 10a is located at the first position P1.

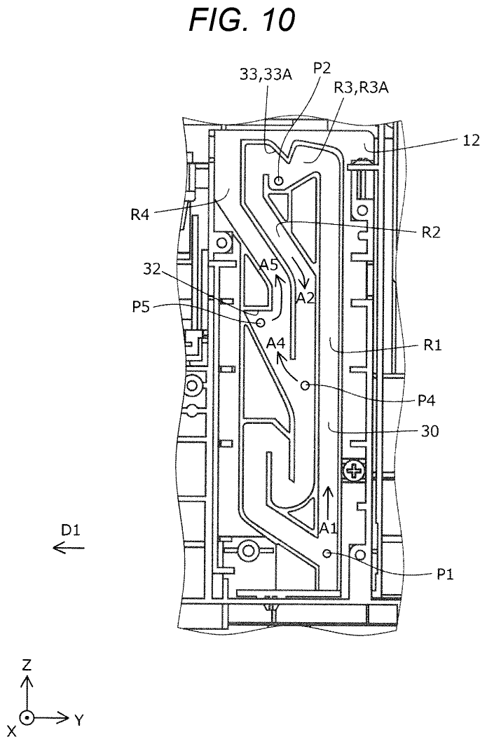

Subsequently, mainly with reference to FIG. 10, disposition of the projection 10a in the cam groove 30 involved in opening and closing operations of the upper unit 3 in the case in which the operator detaches the arm 10 according to, for example, the operator maintaining the printer 1 is described. By changing the upper unit 3 from the closed position illustrated in FIG. 1 to the first open position illustrated in FIG. 2, the projection 10a is displaced from the first position P1 to the second position P2 as described above.

By once opening the upper unit 3 from the first open position and thereafter closing the upper unit 3, the projection 10a is disposed at the fourth position P4, which is the branching position, provided halfway in the second route R2. Thereafter, the upper unit 3 is opened again to dispose the projection 10a at a fifth position P5. Then, the projection 10a advances on the third route R4 as indicated by an arrow A4. FIG. 4 illustrates disposition of the upper unit 3 with respect to the lower unit 2 at the time when the projection 10a is disposed at the fifth position P5. As described above, since the arm 10 is urged by the torsion spring 11 in the first direction D1, which is the apparatus rear side, the arm 10 butts against the projection 32 provided at the fifth position P5 and protruding to the apparatus front side. In this state, when the operator opens the upper unit 3 with respect to the lower unit 2 while pressing the arm 10 to the apparatus front side, which is a direction opposite to the first direction D1, the projection 10a advances on the third route R4 as indicated by an arrow A5. As a result, the arm 10 is discharged from the opening 9c.

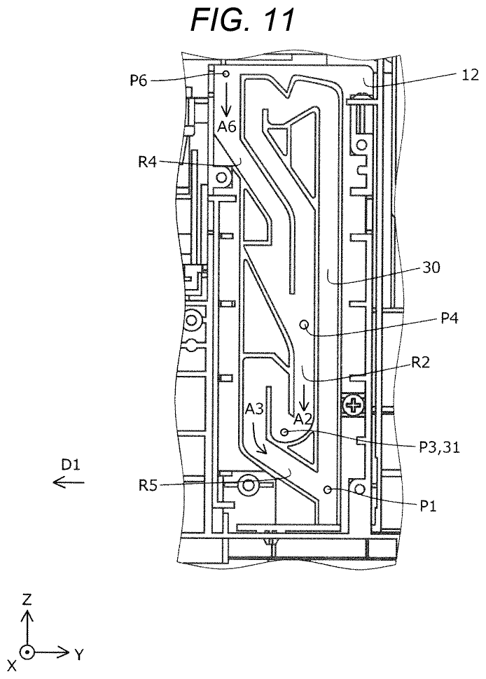

Subsequently, mainly with reference to FIG. 11, disposition of the projection 10a in the cam groove 30 involved in the opening and closing operations of the upper unit 3 in the case in which the operator inserts the arm 10 from the opening 9c is described. Work of the operator inserting the arm 10 from the opening 9c is performed, for example, after maintenance of the printer 1 ends. When the arm 10 is inserted from the opening 9c, the projection 10a advances, from the sixth position P6 corresponding to the entrance of the third route R4, on the third route R4 and the second route R2 as indicated by an arrow A6 and is located at the third position P3. This state corresponds to FIG. 3. In transition from the state in FIG. 3 to the state in FIG. 1, as described above, the upper unit 3 is once opened with respect to the lower unit 2 and thereafter closed. As described above, in the printer 1 in the present embodiment, the arm 10 can be easily detached from the lower unit 2 and thereafter the arm 10 can be easily attached to the lower unit 2.

Here, as illustrated in FIG. 8, the second route R2 includes a linear extension route R2A. The third route R4 includes a linear route R4A extending along the extension route R2A. With such a configuration, the printer 1 in the present embodiment can suppress expansion of the second route R2 and the third route R4 in the Y direction. For this reason, the printer 1 in the present embodiment is reduced in size. However, the printer 1 is not limited to such a configuration. The third route R4 for detaching the arm 10 from the lower unit 2 may be provided in a place different from the printer 1 in the present embodiment, for example, provided halfway in the transition route R3.

As illustrated in FIG. 8, the first route R1 includes a linear route RIA extending in the vertically upward direction. Further, the second route R2 includes a route R2B bending in a direction opposite to the first direction D1 toward the vertically downward direction. The transition route R3 includes a route R3A extending in the obliquely downward direction from the upper end of the first route R1 and then extending in the obliquely upward direction toward the upper end of the second route R2. The recess 31 includes the second position P2 serving as the first recess provided in the transition route R3 and the third position P3 serving as the second recess provided at a position vertically below the second position P2 in the second route R2. Here, the second position P2 and the third position P3 are arranged side by side along the vertical direction. With such a configuration, the printer 1 in the present embodiment can suppress expansion of the transition route R3 and the second route R2 in the Y direction. For this reason, the printer 1 in the present embodiment is reduced from such a point of view as well.

As described above, the arm 10 includes the torsion spring 11 as a pressing section that presses the arm 10 in the first direction D1 such that the projection 10a moves in the certain direction. In the printer 1 in the present embodiment, since the projection 10a is pressed by the torsion spring 11 to move in the certain direction, that is, the appropriate moving direction, the projection 10a can appropriately move in the certain direction. In the printer 1 in the present embodiment, since a guide surface 33 described in detail below is provided, the torsion spring 11 can be omitted. That is, even when the torsion spring 11 is omitted, the projection 10a can continue to move in the cam groove 30 in the certain direction.

As described above, the printer 1 in the present embodiment includes the torsion spring 11 that presses the arm 10 in the first direction D1. For this reason, in the third route R4, when the upper unit 3 is moved in the opening direction with respect to the lower unit 2, the arm 10 is pressed in the first direction D1 by the torsion spring 11. For this reason, when the projection 10a passes on the third route R4, the projection 10a butts against the projection 32 serving as the butting section. With such a configuration, the printer 1 in the present embodiment can prevent the arm 10 from unintentionally slipping out from the opening 9c when the operator opens the upper unit 3.

As illustrated in FIG. 8 and the like, in the printer 1 in the present embodiment, the second route R2 is disposed further on the first direction D1 side than the first route R1 and the third route R4 is disposed further on the first direction D1 side than the second route R2. As described above, the transition route R3 is configured such that the projection 10a moves from the first route R1 to the second route R2 when the upper unit 3 is moved in the closing direction with respect to the lower unit 2 and thereafter moved in the opening direction. The second route R2 is configured such that the projection 10a reaches the return route R5 returning to the first route R1 when the upper unit 3 is moved in the closing direction with respect to the lower unit 2 when the projection 10a is present at the fourth position P4 that is the branching position. On the other hand, the second route R2 is configured such that the projection 10a reaches the third route R4 when the upper unit 3 is moved in the opening direction with respect to the lower unit 2 when the projection 10a is present at the fourth position P4 which is the branching position.

As described above, the second route R2 is disposed further on the first direction D1 side than the first route R1 and the third route R4 is disposed further on the first direction D1 side than the second route R2. With this configuration, the projection 10a can be moved from the first route R1 to the second route R2 and can be moved from the second route R2 to the third route R4 by a pressing force of the torsion spring 11. The transition route R3 is configured such that the projection 10a moves from the first route R1 to the second route R2 when the upper unit 3 is moved in the closing direction and thereafter moved in the opening direction. The second route R2 can return the projection 10a to the first route R1 by closing the upper unit 3 when the projection 10a is present at the branching position. The arm 10 can be discharged from the opening 9c by opening the upper unit 3 when the projection 10a is present at the branching position. For this reason, the printer 1 is configured to be able to easily dispose the upper unit 3 at a desired position with respect to the lower unit 2.

The cam groove 30 includes, on the upper side of the recess 31, the guide surface 33 that guides the projection 10a in the certain direction. Specifically, as illustrated in FIG. 8, the cam groove 30 includes a guide surface 33A on the upper side of the second position P2 in the recess 31 and includes a guide surface 33B on the upper side of the third position P3 in the recess 31. With such a configuration, the printer 1 can restrict the moving direction of the projection 10a to an appropriate direction when the upper unit 3 is closed from a state in which the projection 10a is supported by the recess 31. The state in which the projection 10a is supported by the recess 31 is a state in which the open posture of the upper unit 3 is maintained.

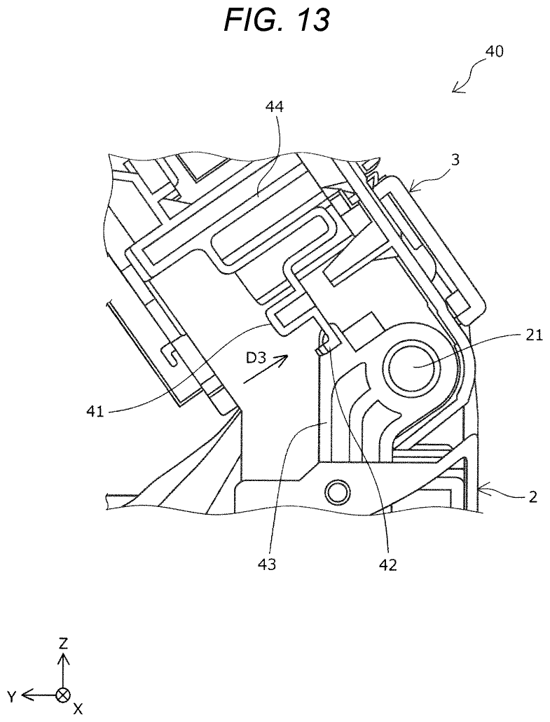

In the printer 1, the upper unit 3 can be detached from the lower unit 2 by opening the upper unit 3 to the fifth open position illustrated in FIG. 12. As illustrated in FIG. 12, a lock mechanism 40 is provided near the hinge 21. The lock mechanism 40 includes an operation section 41. As illustrated in FIG. 13, the operation section 41 can be pressed in a pressing direction D3. The pressing direction D3 is a direction from the apparatus front side toward the apparatus rear side. In the fifth open position illustrated in FIG. 12, the upper unit 3 can be detached from the lower unit 2 by sliding the upper unit 3 in a +X direction with respect to the lower unit 2 while maintaining a state in which the operation section 41 of the lock mechanism 40 is pressed in the pressing direction D3 illustrated in FIG. 13.

In a state in which the upper unit 3 is disposed at the fifth open position illustrated in FIG. 12, an engaging section 42 of the lock mechanism 40 overlaps a section to be engaged 43 provided in the lower unit 2 in the X direction as illustrated in FIG. 13. For this reason, in this state, even if it is attempted to slide the upper unit 3 with respect to the lower unit 2 in the +X direction, the engaging section 42 interferes with the section to be engaged 43. When the operation section 41 coupled to a leaf spring 44 is pressed in the pressing direction D3 in a state of being disposed at the fifth open position illustrated in FIG. 12, the position of the engaging section 42 and the position of the section to be engaged 43 viewed from the X direction deviate. As a result, the upper unit 3 can be slid in the +X direction with respect to the lower unit 2.

As described above, in the printer 1, the lock mechanism 40 that restricts detachment of the upper unit 3 serving as a scanner unit. Accordingly, it is possible to prevent the operator from unintentionally detaching the upper unit 3 from the lower unit 2. As a result, for example, it is possible to reduce a risk of a cable in a state of being connected by the upper unit 3 and the lower unit 2, a connector of the cable, and the like being damaged.

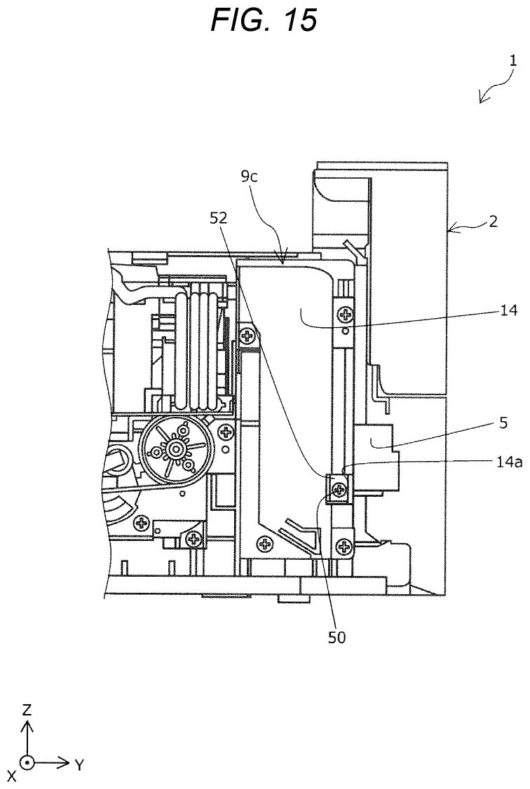

In the printer 1 in the present embodiment, as described above, the cam grooves 30 are provided in both the first frame member 12 and the second frame member 14. Here, as illustrated in FIGS. 14 and 15, in the second frame member 14, a through hole 14a penetrating in the X direction is provided. As illustrated in FIG. 14, a guide section 51 is provided in the printer 1. The paper discharge tray 5 is attached to the guide section 51. The guide section 51 guides movement of the paper discharge tray 5 in the Y direction. As illustrated in FIG. 15, the guide section 51 is screwed to a frame section 52 of the lower unit 2 in the X direction by a screw 50.

As described above, in the printer 1, when the guide section 51 is attached to the frame section 52 of the lower unit 2, the guide section 51 can be screwed via the through hole 14a. In other words, in the printer 1 in the present embodiment, the guide section 51 can be attached to the frame section 52 of the lower unit 2 without detaching the second frame member 14. Therefore, workability is high.

The present disclosure is not limited to the embodiment described above. Various modifications are possible within the scope of the disclosure described in the claims. It is needless to say that the modifications are also included within the scope of the present disclosure.

What is claimed is:

1. A recording apparatus comprising:
a lower unit including a recording section configured to perform recording on a medium; and
an upper unit including a reading section configured to read an image of a document, the upper unit being provided in an upper part of the lower unit and being openable and closable with respect to the lower unit, wherein
the upper unit includes an arm supported by the lower unit and configured to maintain an open state of the upper unit,
the arm is rotatably provided with respect to the upper unit,
the lower unit includes:
a housing configuring an outer shell;
an opening formed in an upper part of the housing, the arm entering the opening; and
a cam groove configured to receive a projection provided on the arm, a route on which the projection moves in a certain direction when the upper unit is opened and closes being formed in the cam groove,
a recess into which the projection enters and that supports the projection from below is provided in the cam groove,
an open state of the upper unit is maintained when the projection enters the recess, and
the cam groove includes:
a first route that is a route on which the projection passes when the upper unit is opened from a closed state;
a second route that is a route on which the projection passes when the upper unit is closed from the open state;
a transition route that is a route on which the projection passes when moving from the first route to the second route; and
a third route that is a route for enabling the arm to be attached and detached.

2. The recording apparatus according to claim 1, wherein
the second route includes a linear extension route, and
the third route includes a linear route extending along the extension route.

3. The recording apparatus according to claim 1, wherein
the first route includes a linear route in a vertically upward direction,
the second route includes a route bent in a vertically downward direction,
the transition route includes a route directed in an obliquely downward direction from an upper end of the first route and then directed in an obliquely upward direction toward an upper end of the second route,
the cam groove includes, as the recess, a first recess provided in the transition route and a second recess provided at a position vertically lower than the first recess in the second route, and
the first recess and the second recess are disposed side by side in a vertical direction.

4. The recording apparatus according to claim 1, further comprising a pressing section configured to press the arm in a first direction such that the projection moves in the certain direction.

5. The recording apparatus according to claim 4, wherein the third route includes a butting section against which the projection butts when the projection passes the third route according to the arm being pressed in the first direction by the pressing section when the upper unit is moved in an opening direction with respect to the lower unit.

6. The recording apparatus according to claim 4, wherein
the third route branches from the second route at a branching position in the second route,
the second route is disposed further on the first direction side than the first route and the third route is disposed further on the first direction side than the second route,
the transition route is configured such that the projection moves from the first route to the second route when the upper unit is moved in a closing direction with respect to the lower unit and thereafter moved in an opening direction, and
the second route is configured such that, when the projection is present at the branching position, the projection reaches a return route returning to the first route when the upper unit is moved in the closing direction with respect to the lower unit and reaches the third route when the upper unit is moved in the opening direction with respect to the lower unit.

7. The recording apparatus according to claim 1, wherein the cam groove includes, on an upper side of the recess, a guide surface that guides the projection in the certain direction.
